(19) United States
(12) Patent Application Publication
(10) Pub. No.: US 2026/0062311 A1
(43) Pub. Date: Mar. 5, 2026

(54) METHOD FOR PREPARING POSITIVE ELECTRODE MATERIAL AND ENERGY STORAGE BATTERY

(71) Applicant: Zhejiang Jinko Energy Storage Co., Ltd., Haining City (CN)

(72) Inventor: Mengting LU, Haining City (CN)

(21) Appl. No.: 18/934,186

(22) Filed: Oct. 31, 2024

(30) Foreign Application Priority Data
Aug. 30, 2024 (CN) 202411214830.4

(51) Int. Cl. C01G 49/00; H01M 4/02; H01M 4/04; H01M 4/58

(52) U.S. Cl. CPC C01G 49/009; H01M 4/0404; H01M 4/5825; C01P 2004/38; C01P 2006/12; H01M 2004/021

(57) ABSTRACT

A method for preparing a positive electrode material and an energy storage battery are provided. The method includes: preparing an Fe-MOF, including: dispersing a first iron source in a solvent, adding the cyanamide organic ligands into the solvent to perform reflux reaction to obtain a reaction solution, and performing cooling, filtering, and cleaning on the reaction solution to obtain the Fe-MOF; grinding and blending the Fe-MOF with a second iron source, a lithium source, and a phosphorus source to obtain a premix; and performing a sintering treatment on the premix under an atmosphere of an inert gas to obtain a composite lithium iron phosphate positive electrode material. The composite lithium iron phosphate positive electrode material includes lithium iron phosphate particles and carbon nanotubes, the lithium iron phosphate particles are attached to a surface of the carbon nanotubes, and there is iron wrapped by each of the carbon nanotubes.

### CROSS REFERENCE TO RELATED APPLICATIONS

The present application claims the benefit of priority under the Paris Convention to Chinese Patent Application No. 202411214830.4 filed on Aug. 30, 2024, which is incorporated herein by reference in its entirety.

### TECHNICAL FIELD

The various embodiments described in this document relate in general to the technical field of batteries, and more specifically to a method for preparing a positive electrode material and an energy storage battery.

### BACKGROUND

With the research and development of lithium-ion batteries, there is an increasingly requirement on energy density, working voltage, and cycle life of the lithium-ion battery. At present, materials for positive electrode of the lithium-ion batteries mainly include lithium iron phosphate (LiFePO4), lithium cobalt oxide, lithium manganate, ternary materials, or the like. The lithium iron phosphate is widely used since the lithium iron phosphate has high capacity, high safety, and long cycle life and is environmental friendliness.

However, lithium iron phosphate positive electrode materials are hard to achieve further development due to the inherent poor electrical conductivity.

### SUMMARY

Embodiments of the present disclosure provide a method for preparing a positive electrode material and an energy storage battery.

According to some embodiments of the present disclosure, a method for preparing a positive electrode material is provided and includes: preparing an iron-based metal-organic framework material (Fe-MOF), where a metal element of the Fe-MOF include iron and organic ligands of the Fe-MOF are cyanamide organic ligands, preparing the Fe-MOF including: dispersing a first iron source in a solvent, adding the cyanamide organic ligands into the solvent having the first iron source to perform reflux reaction to obtain a reaction solution, and performing cooling, filtering, and cleaning on the reaction solution to obtain the Fe-MOF; grinding and blending the Fe-MOF with a second iron source, a lithium source, and a phosphorus source to obtain a premix; and performing a sintering treatment on the premix under an atmosphere of an inert gas to obtain a composite lithium iron phosphate positive electrode material, where the composite lithium iron phosphate positive electrode material includes lithium iron phosphate particles and carbon nanotubes, the lithium iron phosphate particles are attached to a surface of the carbon nanotubes, and there is iron wrapped by each of the carbon nanotubes.

In some embodiments, each of the first iron source and the second iron source is selected from at least one of ferric nitrate, ferric sulfate, ferric acetate, ferric phosphate, ferric chloride, ferrous perchlorate, ferrous phosphate, ferric citrate, ferrous sulfate, ferrous acetate, ferrous nitrate, ferrous oxalate, or ferrous fluoride.

In some embodiments, each of the cyanamide organic ligands is selected from at least one of melamine, dicyandiamide, or cyanamide.

In some embodiments, during preparing of the Fe-MOF, a molar ratio of the cyanamide organic ligands to the first iron source is in a range of 0.2 to 1, a temperature for the reflux reaction is in a range of 80° C. to 180° C., and a time for the reflux reaction is in a range of 2 h to 24 h.

In some embodiments, the Fe-MOF has a specific surface area in a range of 150 m²/g to 1000 m²/g.

In some embodiments, the Fe-MOF has a particle shape of a cube, and the cube has a length of 50 nm to 100 nm.

In some embodiments, the method further includes the following before grinding and blending the Fe-MOF with the second iron source, the lithium source, and the phosphorus source to obtain the premix: blending the Fe-MOF with an adhesive and water to obtain a mixture, and extruding the mixture into a preset shape. Grinding and blending the Fe-MOF with the second iron source, the lithium source, and the phosphorus source to obtain the premix includes: blending the mixture in the preset shape with the second iron source, the lithium source, and the phosphorus source to obtain the premix.

In some embodiments, a sintering temperature for the sintering treatment is in a range of 500° C. to 850° C., a heating rate for the sintering treatment is in a range of 1° C./min to 10° C./min, and a sintering time for the sintering treatment is in a range of 10 h to 24 h.

In some embodiments, the composite lithium iron phosphate positive electrode material has a specific surface area of 5 m²/g to 20 m²/g, and a particle size corresponding to that a cumulative particle size distribution percentage of particles of the composite lithium iron phosphate positive electrode material reaches 50% is in a range of 50 nm to 2000 nm.

In some embodiments, an energy storage battery, includes: a positive electrode sheet and a negative electrode sheet, where the positive electrode sheet includes a positive electrode material prepared according to the method described in any embodiment of the above.

### BRIEF DESCRIPTION OF THE DRAWINGS

One or more embodiments are illustrated by illustrations with reference to the corresponding drawings which do not constitute a limitation of the embodiments and the figures in the drawings do not constitute a limitation of scale unless specifically stated. In order to more clearly explain the technical solutions of the embodiments of the present disclosure or in the related technologies, the drawings required to be used in the embodiments will be briefly described below. It will be obvious that the drawings described below are only some embodiments of the present disclosure, and other drawings can be obtained from these drawings without creative effort for those of ordinary skill in the art.

FIG. 1 is a flow chart corresponding to a method for preparing a positive electrode material according to an embodiment of the present disclosure.

FIG. 2 is a scanning electron microscope diagram of a sintered Fe-MOF according to an embodiment of the present disclosure.

FIG. 3 is a cycle performance test diagram of two kinds of energy storage batteries according to an embodiment of the present disclosure.

FIG. 4 is a DC impedance test diagram of two kinds of energy storage batteries according to an embodiment of the present disclosure.

### DETAILED DESCRIPTION OF THE EMBODIMENTS

In view of the above, the conductivity of the positive electrode material in the lithium iron phosphate battery needs to be improved.

Embodiments of the present disclosure provide a method for preparing a positive electrode material and an energy storage battery. In the method for preparing the positive electrode material, a first iron source is reacted with cyanamide organic ligands to prepare an iron-based metal-organic framework material (Fe-MOF), and then the Fe-MOF is blended and sintered with a second iron source, a lithium source, and a phosphorus source to obtain a composite lithium iron phosphate positive electrode material. The second iron source, the lithium source, and the phosphorus source are reacted with each other to generate lithium iron phosphate particles (LiFePO4), and the Fe-MOF is sintered to form the carbon nanotubes have iron (Fe) inside the carbon nanotubes, and the lithium iron phosphate particles are attached to the surface of the carbon nanotubes in microstructure. The ligands in the Fe-MOF are the cyanamide organic ligands. The ligands may form nitrogen-doped bamboo-like carbon nanotubes after high-temperature sintering, and active sites of Fe are wrapped at a front end of the carbon nanotubes. The unique carbon coating structure can protect and fix the active sites of Fe to improve the stability of the iron. In addition, the nitrogen-doped carbon nanotubes can provide efficient electron transport channels to form a continuous three-dimensional conductive network, which can be beneficial to improve the electronic conductivity of the composite lithium iron phosphate positive electrode material and the diffusion rate of lithium ions. In addition, the carbon volatilized by the cyanamide organic ligands during high-temperature sintering can be used as a carbon source to form a carbon-coated layer on a surface of lithium iron phosphate particles without adding additional carbon sources. The carbon-coated lithium iron phosphate particles are beneficial to improve the conductivity of composite lithium iron phosphate positive electrode materials.

In the description of the embodiments of the present disclosure, the technical terms “first”, “second”, and the like are only used to distinguish different objects, and could not be understood as indicating or implicitly indicating relative importance or implicitly indicating the number, specific order, or primary-secondary relationship of the indicated technical features.

Reference herein to an “embodiment” means that a particular feature, structure, or characteristic described in connection with the embodiment may be included in at least one embodiment of the present disclosure. The appearance of the phrase in various embodiments in the specification does not necessarily refer to the same embodiments, nor is it an independent or alternative embodiment that is mutually exclusive from other embodiments. It is explicitly and implicitly understood by those skilled in the art that the embodiments described herein may be combined with other embodiments.

In the description of embodiments of the present disclosure, when a certain component “includes” another component, other components are not excluded unless otherwise specified, and other components may be further included.

The terminology used in the description of the various described embodiments herein is for the purpose of describing particular embodiments only and is not intended to be limiting. As used in the description of the various embodiments described and the appended claims, “component” is also intended to include the plural form unless the context clearly dictates otherwise.

Hereinafter, various embodiments of the present disclosure will be described in detail. However, one of ordinary skill in the art will appreciate that many technical details have been set forth in various embodiments of the present disclosure in order to better understand the present disclosure by the reader. However, even without these technical details and various changes and modifications based on the following embodiments, the technical solutions claimed in the present disclosure can be realized.

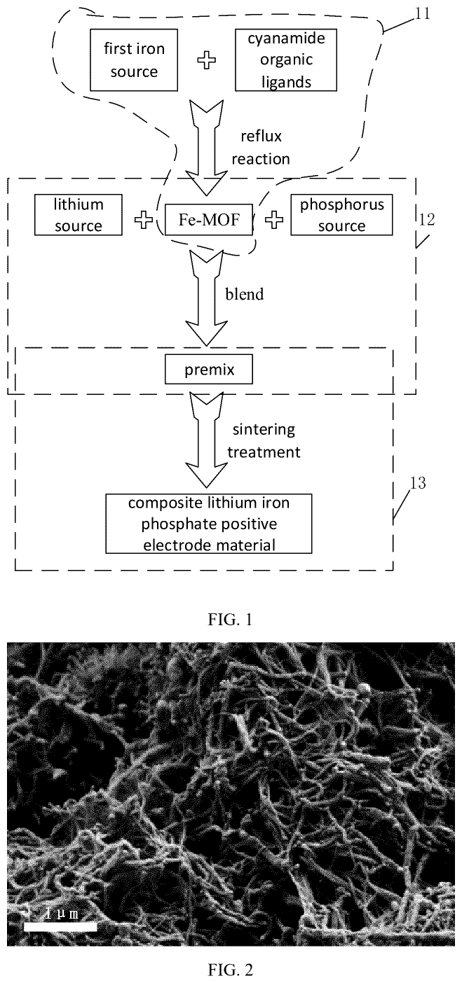

FIG. 1 is a flow chart corresponding to a method for preparing a positive electrode material according to an embodiment of the present disclosure.

Referring to FIG. 1, according to some embodiments of the present disclosure, a method for preparing a positive electrode material is provided.

At block 11, an iron-based metal-organic framework material (Fc-MOF) is prepared, where a metal element of the Fe-MOF is iron (Fe) element, and organic ligands of the Fe-MOF are cyanamide organic ligands. The operations at block 11 are conducted as follows. A first iron source is dispersed in a solvent, the cyanamide organic ligands are added into the solvent having the first iron source to carry out reflux reaction to obtain a reaction solution, and cooling, filtering, and cleaning are performed on the reaction solution to obtain the Fe-MOF. The Fe-MOF is in the form of blue powder.

The first iron source may be selected from one or more of ferric nitrate, ferric sulfate, ferric acetate, ferric phosphate, ferric chloride, ferrous perchlorate, ferrous phosphate, ferric citrate, ferrous sulfate, ferrous acetate, ferrous nitrate, ferrous oxalate, or ferrous fluoride.

The solvent may be selected from one or more of dimethylformamide (DMF), diethylformamide (DEF), dimethylacetamide (DMA), water, ethanol, methanol, ethanol, propanol or acetone. The solvent is selected to facilitate the dispersion of the first iron source, so as to facilitate the subsequent reaction between the first iron source and the cyanamide organic ligands to form the Fe-MOF.

The cyanamide organic ligands may be selected from one or more of melamine, dicyandiamide, or cyanamide.

A molar ratio of the cyanamide organic ligands to the first iron source may be in a range of 0.2 to 1, for example, 0.2 to 0.4, 0.4 to 0.6, 0.6 to 0.8, or 0.8 to 1. Specifically, the molar ratio of the cyanamide organic ligands to the first iron source may be 0.2, 0.3, 0.4, 0.5, 0.6, 0.7, 0.8, 0.9, or 1.

In some embodiments, a surfactant may be added into the solvent with the cyanamide organic ligands. The surfactant may be selected from the group consisting of cetyltrimethyl ammonium bromide, sodium dodecylbenzene sulfonate, polyvinylpyrrolidone, ammonium dodecylsulfate, dodecylbenzene sulfonic acid, and the like.

A molar ratio of the surfactant to the cyanamide organic ligands is in a range of 0.1 to 0.3, for example, 0.1 to 0.2 or 0.2 to 0.3. Specifically, the molar ratio of the surfactant to the cyanamide organic ligands is 0.1, 0.13, 0.15, 0.18, 0.2, 0.22, 0.25, 0.28, 0.3, or the like.

In some embodiments, in the microstructure, the Fe-MOF has a cuboid particle shape. A length of the cuboid is in a range of 50 nm to 100 nm, for example, 50 nm to 70 nm, 70 nm to 90 nm, or 90 nm to 100 nm. Specifically, the length of the cuboid is 50 nm, 56 nm, 60 nm, 64 nm, 70 nm, 73 nm, 80 nm, 88 nm, 90 nm, 95 nm, or 100 nm. It shall be understood that different single Fe-MOFs may have different particle sizes, and therefore, the particle sizes of Fe-MOFs fluctuate within a certain range.

The microstructure can be observed by scanning electron microscope (SEM), transmission electron microscope (TEM), atomic force microscope (AFM), and other detection means.

In some embodiments, a specific surface area of the Fe-MOF is in a range of 150 m²/g to 1000 m²/g, such as 150 m²/g to 250 m²/g, 250 m²/g to 460 m²/g, 460 m²/g to 750 m²/g, or 750 m²/g to 1000 m²/g. Specifically, the specific surface area of the Fe-MOF is 150 m²/g, 190 m²/g, 250 m²/g, 340 m²/g, 460 m²/g, 570 m²/g, 640 m²/g, 750 m²/g, 880 m²/g, 940 m²/g, or 1000 m²/g. The specific surface area refers to a total surface area of particles per unit of volume or per unit of mass. It shall be understood that the particle sizes of different single Fe-MOFs are different, and thus, the total surface area of particles of the Fe-MOF fluctuates within a range in Fe-MOFs with different unit volumes or different unit masses, that is, the specific surface areas of the Fe-MOF fluctuate within a certain range. The smaller the particle size of the Fe-MOF, the larger the specific surface area of the Fe-MOF. On the contrary, the larger the particle size of Fe-MOF, the smaller the specific surface area of Fe-MOF.

During preparing of Fe-MOF, a temperature for the reflux reaction may be in a range of 80° C. to 180° C., for example, 80° C. to 100° C., 100° C. to 158° C., or 158° C. to 180° C. Specifically, the temperature for the reflux reaction is 80° C., 90° C., 100° C., 115° C., 134° C., 146° C., 158° C., 163° C., 170° C., 175° C., or 180° C. A time required for the reflux reaction may be in a range of 2 hours (h) to 24 h, for example, 2 h to 6 h, 6 h to 10 h, 10 h to 15 h, 15 h to 20 h, or 20 h to 24 h. Specifically, the time required for the reflux reaction is 2 h, 4 h, 6 h, 8 h, 11 h, 15 h, 19 h, 20 h, 22 h or 24 h. The temperature and time for the reflux reaction can be adjusted within a certain range. A suitable temperature and time are conducive to the full progress of the reaction. By controlling the parameters such as the temperature and time for the reflux reaction within a suitable range, iron ions and cyanamide organic ligands can be promoted to form coordination complex/metal complex and improve the efficiency of building metal-organic frameworks.

At block 12, the Fe-MOF is ground and blended with a second iron source, a lithium source, and a phosphorus source to obtain a premix.

The second iron source may be selected from one or more of ferric nitrate, ferric sulfate, ferric acetate, ferric phosphate, ferric chloride, ferrous perchlorate, ferrous phosphate, ferric citrate, ferrous sulfate, ferrous acetate, ferrous nitrate, ferrous oxalate, or ferrous fluoride.

The lithium source may be selected from the group consisting of lithium carbonate, lithium hydroxide, lithium nitrate, lithium sulfate, lithium phosphate, lithium permanganate, lithium metaphosphate, lithium fluoride, lithium bromide, lithium oxalate, lithium formate, lithium citrate, lithium salicylate, lithium trifluoroacetate, lithium acetoacetate, lithium difluorophosphate, lithium hexafluorophosphate, lithium benzoate, lithium pyruvate, lithium acetate, and the like.

The phosphorus source may be selected from one or both of diammonium hydrogen phosphate and ammonium dihydrogen phosphate.

In a specific example, a molar ratio of the Fe-MOF, the second iron source, the lithium source, and the phosphorus source is 1:1:1:1.

In some embodiments, grinding and blending the Fe-MOF with the second iron source, the lithium source, and the phosphorus source is achieved by performing ball milling treatment. A ball-to-powder weight ratio of the ball milling treatment may be in a range of 1:1 to 10:1, for example, 1:1 to 3:1, 3:1 to 6:1, or 6:1 to 10:1. Specifically, the ball-to-powder weight ratio of the ball milling treatment is 1:1, 2:1, 3:1, 4:1, 5:1, 6:1, 7:1, 8:1, 9:1, or 10:1. A rotational speed of the ball milling treatment may be in a range of 100 rpm/min to 400 rpm/min, for example, 100 rpm/min to 180 rpm/min, 180 rpm/min to 250 rpm/min, or from 250 rpm/min to 400 rpm/min. Specifically, the rotational speed of the ball milling treatment is 100 rpm/min, 130 rpm/min, 160 rpm/min, 180 rpm/min, 200 rpm/min, 220 rpm/min, 250 rpm/min, 290 rpm/min, 310 rpm/min, 360 rpm/min, or 400 rpm/min. A time required for the ball milling treatment may be in a range of 0.5 h to 2 h, for example, 0.5 h to 0.9 h, 0.9 h to 1.5 h, or 1.5 h to 2 h. Specifically, the time required for the ball milling treatment is 0.5 h, 0.4 h, 0.6 h, 0.9 h, 1 h, 1.3 h, 1.5 h, 1.6 h, 1.8 h, or 2 h. The ball-to-powder weight ratio refers to a ratio of a mass of a material in a ball mill to a mass of a grinding body.

At block 13, a sintering treatment is performed on the premix under an atmosphere of an inert gas to obtain a composite lithium iron phosphate positive electrode material. The composite lithium iron phosphate positive electrode material includes lithium iron phosphate particles (LiFePO4) and carbon nanotubes. The lithium iron phosphate particles are attached to a surface of the carbon nanotubes in a microstructure, and there is iron (elementary substance, Fe) wrapped by each of the carbon nanotubes.

The microstructure can be observed by SEM, TEM, AFM, and other detection means.

In some embodiments, a sintering temperature for the sintering treatment may be in a range of 500° C. to 850° C., such as, 500° C. to 640° C., 640° C. to 780° C., or 780° C.-850° C. Specifically, the sintering temperature is 500° C., 530° C., 560° C., 590° C., 610° C., 640° C., 670° C., 700° C., 750° C., 780° C., 800° C., 850° C., or the like. A heating rate for the sintering treatment may be in a range of 1° C./min to 10° C./min, for example, 1° C./min to 5° C./min, 5° C./min to 8° C./min, or 8° C./min to 10° C./min. Specifically, the heating rate is 1° C./min, 3° C./min, 5° C./min, 7° C./min, 8° C./min, or 10° C./min. A sintering time may be in a range of 10 h to 24 h, for example, 10 h to 16 h, 16 h to 20 h, or 20 h to 24 h, and specifically, 10 h, 12 h, 15 h, 16 h, 18 h, 20 h, 21 h, 24 h, or the like.

In some embodiments, the inert gas may be nitrogen, argon, helium, or the like.

In some embodiments, prior to grinding and blending the Fe-MOF with the second iron source, the lithium source, and the phosphorus source to obtain the premix, the method further includes the following. The Fe-MOF is blended with an adhesive and water to obtain a mixture, and the mixture is extruded into a preset shape. Grinding and blending the Fe-MOF with the second iron source, the lithium source, and the phosphorus source to obtain the premix are performed as follows. The mixture with the preset shape is blended with the second iron source, the lithium source, and the phosphorus source to obtain the premix. Generally, most of positive electrode materials are in the form of powder or gel. The positive electrode materials of the powder shape are difficult to transport and use, which limits the prospect of industrialization of positive electrode materials. The positive electrode materials of the gel shape may reduce the porosity of the positive electrode materials and affect mechanical properties of the positive electrode materials. Compared with the transportation of positive electrode materials of the gel and powder forms, blending Fe-MOF with the adhesive and the water and then extruding the mixture into the preset shape can facilitate the transportation of Fe-MOF materials and avoiding gels from affecting the properties of the Fe-MOF materials.

In some embodiments, the preset shape may be a cube, a cylinder, a sphere, or the like.

The adhesive may be selected from the group consisting of polyacrylic acid, carboxymethyl cellulose, polymethyl methacrylate, chitosan, carboxyethyl cellulose, polyvinyl alcohol, polyvinyl butyraldehyde, polyvinylpyridinone, methyl cellulose, hydroxypropyl cellulose, and the like.

A ratio of mass of the adhesive to mass of the Fe-MOF may be in a range of 0.05 to 0.2, for example, 0.05 to 0.13, 0.13 to 0.17, or 0.17 to 0.2, and specifically 0.05, 0.08, 0.1, 0.13, 0.15, 0.17, 0.19, or 0.2.

A ratio of mass of the water to the mass of the mixture is in a range of 0.1 to 0.5, for example 0.1 to 0.26, 0.26 to 0.34, 0.34 to 0.45 or 0.45 to 0.5, specifically, 0.1, 0.15, 0.2, 0.26, 0.3, 0.34, 0.4, 0.45 or 0.5.

A pressure for the extruding the mixture into the preset shape may be in a range of 70 kgf/cm² to 250 kgf/cm², for example 70 kgf/cm² to 100 kgf/cm², 100 kgf/cm² to 150 kgf/cm², 150 kgf/cm² to 180 kgf/cm², 180 kgf/cm² to 230 kgf/cm², or 230 kgf/cm² to 250 kgf/cm², specifically 70 kgf/cm², 80 kgf/cm², 90 kgf/cm², 100 kgf/cm², 120 kgf/cm², 140 kgf/cm², 150 kgf/cm², 160 kgf/cm², 180 kgf/cm², 200 kgf/cm², 230 kgf/cm², or 250 kgf/cm².

In some embodiments, a specific surface area of the composite lithium iron phosphate positive electrode material is in a range of 5 m²/g to 20 m²/g, for example, 5 m²/g to 8 m²/g, 8 m²/g to 10 m²/g, 10 m²/g to 15 m²/g, or 15 m²/g to 20 m²/g, specifically 5 m²/g, 6.5 m²/g, 8 m²/g, 10.2 m²/g, 15 m²/g, 18.6 m²/g, 19 m²/g, or 20 m²/g. The specific surface area refers to a total surface area of particles per unit of volume or per unit of mass. Different single composite lithium iron phosphate positive electrode materials may have different particle sizes, and thus, the total surface area of the particles of the composite lithium iron phosphate positive electrode material fluctuates within a range in the composite lithium iron phosphate positive electrode materials with different unit volumes or different unit masses. That is, the specific surface areas of the composite lithium iron phosphate positive electrode materials fluctuate within a certain range. The smaller the particle size of the composite lithium iron phosphate positive electrode material, the larger the specific surface area of the composite lithium iron phosphate positive electrode material. The larger the particle size of the composite lithium iron phosphate positive electrode material, the smaller the specific surface area of the composite lithium iron phosphate positive electrode material.

In some embodiments, when the cumulative particle size distribution percentage of particles of the composite lithium iron phosphate positive electrode material reaches 50%, a particle size is in a range of 50 nm to 2000 nm, e.g., 50 nm to 300 nm, 300 nm to 600 nm, 600 nm to 1230 nm, 1230 nm to 1654 nm, or 1654 nm to 2000 nm, specifically 50 nm, 100 nm, 300 nm, 600 nm, 900 nm, 1000 nm, 1230 nm, 1450 nm, 1188 nm, 1300 nm, 1654 nm, 1741 nm, or 2000 nm. The average particle size of the composite lithium iron phosphate positive electrode material refers to the particle size when the cumulative particle size distribution percentage of the particles of the composite lithium iron phosphate positive electrode material reaches 50%.

In some embodiments, a carbon coating content of the composite lithium iron phosphate positive electrode material may be in a range of 0.1% to 1.5%, e.g., 0.1%, 0.25%, 0.3%, 0.5%, 0.8%, 1%, 1.1%, 1.3%, or 1.5%. The carbon coating content is generally expressed by a mass fraction of carbon in the composite lithium iron phosphate positive electrode material, and the carbon coating content can be measured by an infrared sulfur-carbon analyzer. The carbon coating content affects the electrical properties of the positive electrode material. If the carbon coating content is within an appropriate range, it can be beneficial to the better conductivity of the composite lithium iron phosphate positive electrode material and the energy density of the lithium iron phosphate battery.

In the method for preparing the positive electrode material provided by the embodiments of the present disclosure, the first iron source is reacted with the cyanamide organic ligands to prepare the iron-based metal-organic framework material (Fe-MOF), and then the Fe-MOF is blended and sintered with the second iron source, the lithium source, and the phosphorus source to obtain the composite lithium iron phosphate positive electrode material. The second iron source, the lithium source, and the phosphorus source react with each other to generate lithium iron phosphate particles, and the Fe-MOF is sintered to form the carbon nanotubes have iron (Fe) inside the carbon nanotubes. The lithium iron phosphate particles are attached to the surface of the carbon nanotubes in the microstructure. Referring to FIG. 2, FIG. 2 is a scanning electron microscope diagram of a sintered Fe-MOF provided by the embodiment of the present disclosure. The ligands in the Fe-MOF are the cyanamide organic ligands. The ligands may form nitrogen-doped bamboo-like carbon nanotubes after high-temperature sintering, and the active sites of Fe are wrapped at the front end of the carbon nanotubes. The unique carbon coating structure can protect and fix the active sites of Fe to improve the stability of the Fe. In addition, the nitrogen-doped carbon nanotubes can provide efficient electron transport channels to form a continuous three-dimensional conductive network, which can be beneficial to improve the electronic conductivity of the composite lithium iron phosphate positive electrode material and the diffusion rate of lithium ions. In addition, the carbon volatilized by the cyanamide organic ligands during high-temperature sintering can be used as a carbon source to form a carbon-coated layer on the surface of lithium iron phosphate particles without adding additional carbon sources. The carbon-coated lithium iron phosphate particles are beneficial to improve the conductivity of composite lithium iron phosphate positive electrode materials.

Accordingly, another embodiment of the present disclosure further provides an energy storage battery, including a positive electrode sheet/plate and a negative electrode sheet/plate. The positive electrode material of the positive electrode sheet is prepared by any one of the methods for preparing the positive electrode material in the above embodiments. For the same or corresponding portions as those of the preceding embodiment, reference may be made to the corresponding description of the preceding embodiment, which will not be described in detail below.

In some embodiments, the positive electrode sheet includes a positive electrode current collector and a positive electrode material layer, and the positive electrode material layer includes a positive electrode material and a positive electrode adhesive layer. The positive electrode material is formed by the method for preparing the positive electrode material in the above embodiments, and the positive electrode material is dispersed in the positive electrode adhesive layer.

In some embodiments, the negative electrode sheet includes a negative electrode current collector and a negative electrode material layer. The negative electrode material layer includes a negative electrode material and a negative electrode adhesive layer. The negative electrode material is dispersed in the negative electrode adhesive layer.

The negative electrode material may be selected from natural graphite, artificial graphite, soft carbon, hard carbon, or the like.

In a specific example, a material of the positive electrode current collector is aluminum foil, and a material of the negative electrode current collector is copper foil.

Both the material of the positive electrode adhesive layer and the material of the negative electrode adhesive layer may be selected from sodium hydroxycellulose, polyvinylidene fluoride, or styrene-butadiene rubber.

The following are specific embodiments of the present disclosure.

### Embodiment 1

In this embodiment, a lithium iron phosphate positive electrode material is prepared, which is prepared as follows.

The Fe-MOF is prepared. Ferric sulfate of 0.4 g is dispersed in 100 g of DMF, melamine of 0.062 g (a molar ratio of melamine to ferric sulfate is 0.5) is added, and reflux reaction is performed at 120° C. for 3 h to obtain a reaction solution, and cooling, filtering, and cleaning are performed on the reaction solution to obtain Fe-MOF of 0.106 g.

The Fe-MOF of 0.1 g is blended with ferric nitrate of 0.4 g, lithium carbonate of 0.08 g, and diammonium hydrogen phosphate of 0.12 g (the molar ratio of Fe-MOF, ferric nitrate, lithium carbonate and diammonium hydrogen phosphate is 1:1:1:1) by performing ball milling treatment to obtain a premix. A ball-to-powder weight ratio of the ball milling treatment is 5:1, a rotation speed for the ball milling treatment is 250 rpm/min, and a time for the ball milling treatment is 1 h.

The premix is subjected to sintering treatment under nitrogen atmosphere to obtain the composite lithium iron phosphate positive electrode material. A temperature for the sintering treatment is 700° C., a heating rate for the for the sintering treatment is 5° C./min, and a sintering time for the sintering treatment is 12 h.

### Embodiment 2

The method described in Embodiment 2 is basically the same as that described in Embodiment 1, except that the mass of melamine is different. In Embodiment 2, the molar ratio of melamine to ferric sulfate is 0.2.

### Embodiment 3

The method described in Embodiment 3 is basically the same as that described in Embodiment 1, except that the mass of melamine is different. In Embodiment 3, the molar ratio of melamine to ferric sulfate is 1.

### Comparative Example 1

In Comparative Example 1, a lithium iron phosphate positive electrode material is prepared, which is prepared as follows.

Ferric nitrate of 0.4 g, lithium carbonate of 0.08 g, and diammonium hydrogen phosphate of 0.12 g (a molar ratio of ferric nitrate, lithium carbonate, and diammonium hydrogen phosphate is 1:1:1) are blended by performing the ball milling treatment to obtain a premix. A ball-to-powder weight ratio of the ball milling treatment is 5:1, a rotating speed for the ball milling treatment is 250 rpm/min, and a time for the ball milling treatment is 1 h.

The premix is subjected to sintering treatment under nitrogen atmosphere to obtain a composite lithium iron phosphate positive electrode material. A temperature for the sintering treatment is 700° C., a heating rate for the for the sintering treatment is 5° C./min, and a sintering time for the sintering treatment is 12 h.

### Comparative Example 2

The method described in Comparative Example 2 is basically the same as that described in Embodiment 1, except that the mass of melamine is different. In Comparative Example 2, a molar ratio of melamine to ferric sulfate is 0.1.

### Comparative Example 3

The method described in Comparative Example 3 is basically the same as that of Embodiment 1, except that the mass of melamine is different. In Comparative Example 3, a molar ratio of melamine to ferric sulfate is 2.

Resistivity tests are performed on the lithium iron phosphate positive electrode materials prepared according to Embodiments 1 to 3 and Comparative Examples 1 to 3, and the test results are shown in the following table.

| | | Ferric | Molar ratio of | Resistivity |
|---|---|---|---|---|
| | Melamine | sulfate | melamine to | at 8 Mpa |
| | (g) | (g) | ferric sulfate | pressure |
| Embodiment 1 | 0.062 | 0.4 | 0.5 | 8.52 |
| Embodiment 2 | 0.025 | 0.4 | 0.2 | 10.88 |
| Embodiment 3 | 0.124 | 0.4 | 1 | 9.56 |
| Comparative | — | — | — | 21.31 |
| Example 1 | | | | |
| Comparative | 0.012 | 0.4 | 0.1 | 23.85 |
| Example 2 | | | | |
| Comparative | 0.249 | 0.4 | 2 | 28.65 |
| Example 3 | | | | |

According to the resistivity test results of Embodiment 1 and Comparative Example 1, it can be found that the composite lithium iron phosphate positive electrode material provided in the embodiment of the present disclosure has better conductivity than the conventional lithium iron phosphate positive electrode material. According to the resistivity test results of Embodiments 1 to 3, Comparative Example 2, and Comparative Example 3, it can be found that when the mass of the first iron source is constant, and the addition amount of the cyanamide organic ligands is controlled within an appropriate range, the cyanamide organic ligands can be ensured to provide sufficient linking sites to fully react with the iron ion and the cyanamide organic ligands, and the composite lithium iron phosphate positive electrode material can have better conductivity.

### Embodiment 4

The method described in Embodiment 4 is basically the same as that of Embodiment 1 except that in Embodiment 4, 0.0359 g of cetyltrimethylammonium bromide (a molar ratio of cetyltrimethylammonium bromide to melamine is 0.2) is added in addition to the addition of melamine.

### Embodiment 5

The method described in Embodiment 5 is basically the same as that of Embodiment 4, except that the mass of cetyltrimethylammonium bromide is different, and in Embodiment 5, a molar ratio of cetyltrimethylammonium bromide to melamine is 0.1.

### Embodiment 6

The method described in Embodiment 6 is basically the same as that of Embodiment 4, except that the mass of cetyltrimethylammonium bromide is different, and in Embodiment 6, a molar ratio of cetyltrimethylammonium bromide to melamine is 0.3.

### Comparative Example 4

The method described in Comparative Example 4 is basically the same as that of Embodiment 4, except that the mass of cetyltrimethylammonium bromide is different, and in Comparative Example 4, a molar ratio of cetyltrimethylammonium bromide to melamine is 0.05.

### Comparative Example 5

The method described in Comparative Example 5 is basically the same as that of Embodiment 4, except that the mass of cetyltrimethylammonium bromide is different, and in Comparative Example 5, a molar ratio of cetyltrimethylammonium bromide to melamine is 0.6.

The tests of specific surface area, the carbon coating content, and the resistivity test are performed on Embodiments 1, and 4 to 6, and Comparative Examples 4 to 5, and the test results were as follows:

| | | Specific | Carbon | |
|---|---|---|---|---|
| | | surface area | coating | |
| | | of composite | content of | |
| | | lithium iron | composite | |
| | | phosphate | lithium iron | |
| | | positive | phosphate | Resistivity |
| | Molar ratio of | electrode | positive | at 8 Mpa |
| | cetyltrimethylammonium | material | electrode | pressure |
| | bromide to melamine | (m²/g) | material (%) | (Ω · cm)) |
| Embodiment 1 | — | 10.22 | 1.24 | 8.52 |
| Embodiment 4 | 0.2 | 12.23 | 1.35 | 5.45 |
| Embodiment 5 | 0.1 | 12.09 | 1.33 | 6.58 |
| Embodiment 6 | 0.3 | 13.83 | 1.42 | 4.26 |
| Comparative | 0.05 | 11.34 | 1.25 | 7.88 |
| Example 4 | | | | |
| Comparative | 0.6 | 25.56 | 1.84 | 3.66 |
| Example 5 | | | | |

Comparing the resistivity of the above Embodiments and comparative examples, it can be found that the addition of surfactant may affect the particle size of Fe-MOF, and then affect the specific surface area and carbon coating content of the composite lithium iron phosphate positive electrode material. The specific surface area and carbon coating content of the composite lithium iron phosphate positive electrode material can be adjusted by adjusting the amount of surfactant, thereby improving the conductivity of the composite lithium iron phosphate positive electrode material. When the amount of surfactant is small, the effect on the specific surface area and carbon coating content of the composite lithium iron phosphate positive electrode material is small, so the improvement in conductivity is not obvious. However, when the amount of surfactant is too large, the specific surface area of the composite lithium iron phosphate positive electrode material is too large, and agglomeration is easy to occur. In addition, if the specific surface area of the composite lithium iron phosphate positive electrode material is too large, the carbon coating content may be higher. Excessive carbon coating content may reduce the proportion and tap density of the lithium iron phosphate active material in the composite lithium iron phosphate positive electrode material, and then affect the volume energy density of the composite lithium iron phosphate positive electrode material.

### Embodiment 7

The method described in Embodiment 7 is basically the same as that of Embodiment 1 except that in Embodiment 7, the ball-to-powder weight ratio is 1:1.

### Embodiment 8

The method described in Embodiment 8 is essentially the same as that of Embodiment 1 except that in Embodiment 8, the ball-to-powder weight ratio is 10:1.

### Comparative Example 6

The method described in Comparative Example 6 is basically the same as that of Embodiment 1 except that in Comparative Example 6, the ball-to-powder weight ratio is 0.5:1.

### Comparative Example 7

The method described in Comparative Example 7 is basically the same as that of Embodiment 1 except that in Comparative Example 7, the ball-to-powder weight ratio is 12:1.

The tests for carbon coating content and the resistivity are performed on Embodiment 1, Embodiment 7, Embodiment 8, Comparative Example 6, and Comparative Example 7, and the test results are as follows.

| | Ball-to- | Carbon coating content of | Resistivity |
|---|---|---|---|
| | powder | composite lithium iron | at 8 Mpa |
| | weight | phosphate positive | pressure |
| | ratio | electrode material (%) | (Ω · cm) |
| Embodiment 1 | 5:1 | 1.24 | 8.52 |
| Embodiment 7 | 1:1 | 1.12 | 9.35 |
| Embodiment 8 | 10:1 | 1.38 | 5.34 |
| Comparative | 0.5:1 | 0.09 | 13.69 |
| Example 6 | | | |
| Comparative | 12:1 | 1.52 | 4.66 |
| Example 7 | | | |

### Embodiment 9

The method described in Embodiment 9 is basically the same as that of Embodiment 1, except that in Embodiment 9, the time of ball milling treatment is 0.5 h.

### Embodiment 10

The method described in Embodiment 10 is basically the same as that of Embodiment 1, except that in Embodiment 10, the time of ball milling treatment is 2 h.

### Comparative Example 8

The method described in Comparative Example 8 is basically the same as that of Embodiment 1, except that in Comparative Example 8, the time of ball milling treatment is 0.2 h.

### Comparative Example 9

The method described in Comparative Example 9 is basically the same as that of Embodiment 1, except that in Comparative Example 9, the time of ball milling treatment is 3 h.

Embodiments 1, 9 and 10 and Comparative Examples 8 and 9 are subjected to a carbon coating content test and a resistivity test, and the test results are as follows.

| | Ball | Carbon coating content | Resistivity |
|---|---|---|---|
| | milling | of composite lithium iron | at 8 Mpa |
| | time | phosphate positive | pressure |
| | (h) | electrode material (%) | (Ω · cm) |
| Embodiment 1 | 1.5 | 1.24 | 8.52 |
| Embodiment 9 | 0.5 | 0.83 | 12.43 |
| Embodiment 10 | 2 | 1.51 | 4.45 |
| Comparative | 0.2 | 0.57 | 18.30 |
| Example 8 | | | |
| Comparative | 3 | 1.65 | 4.05 |
| Example 9 | | | |

### Embodiment 11

The method described in Embodiment 11 is basically the same as that of Embodiment 1, except that in Embodiment 11, the sintering temperature is 500° C.

### Embodiment 12

The method described in Embodiment 12 is basically the same as that of Embodiment 1, except that in Embodiment 12, the sintering temperature is 850° C.

### Comparative Example 10

The method described in Comparative Example 10 is basically the same as that of Embodiment 1 except that in Comparative Example 10, the sintering temperature is 300° C.

### Comparative Example 11

The method described in Comparative Example 11 is basically the same as that of Embodiment 1, except that in Comparative Example 11, the sintering temperature is 1000° C.

Embodiments 1, 11, and 12 and Comparative Examples 10 to 11 are subjected to a carbon coating content test and a resistivity test, and the test results are as follows.

| | | Carbon coating | |
|---|---|---|---|
| | | content of composite | Resistivity |
| | Sintering | lithium iron | at 8 Mpa |
| | temperature | phosphate positive | pressure |
| | (° C.) | electrode materials | (Ω · cm) |
| Embodiment 1 | 700 | 1.24 | 8.52 |
| Embodiment 11 | 500 | 0.84 | 13.65 |
| Embodiment 12 | 850 | 1.33 | 7.42 |
| Comparative | 300 | 0.52 | 16.77 |
| Example 10 | | | |
| Comparative | 1000 | 1.56 | 4.33 |
| Example 11 | | | |

According to the carbon coating content test results and the resistivity test results of Embodiments 1, 7 to 12, and Comparative Examples 6 to 11, it can be found that the carbon coating content of the composite lithium iron phosphate positive electrode material can be controlled by controlling the ball-to-powder weight ratio, the ball milling time, and the sintering temperature. The carbon coating content affects the electrical performance of the composite lithium iron phosphate positive electrode material. If the carbon coating content is within an appropriate range, it can be beneficial for the composite lithium iron phosphate positive electrode material to have better conductivity and keep the lithium iron phosphate battery to have a higher energy density.

### Embodiment 13

The present embodiment provides an energy storage battery, including a positive electrode sheet and a negative electrode sheet. The positive electrode sheet includes an aluminum foil and a positive electrode material layer covering the surface of the aluminum foil. The positive electrode material layer includes polyvinylidene fluoride and a composite lithium iron phosphate material dispersed in the polyvinylidene fluoride, and the composite lithium iron phosphate material is the composite lithium iron phosphate positive electrode material prepared according to the above embodiment 1. The negative electrode sheet includes a copper foil and a negative electrode material layer covering the surface of the copper foil, and the negative electrode material layer includes polyvinylidene fluoride and artificial graphite dispersed in the polyvinylidene fluoride.

### Comparative Example 12

The present embodiment provides an energy storage battery, and the energy storage battery of Comparative Example 12 is basically the same as the energy storage battery of Embodiment 13, except that in Comparative Example 12, the positive electrode material layer includes polyvinylidene fluoride and a lithium iron phosphate material dispersed in the polyvinylidene fluoride, and the lithium iron phosphate material is the lithium iron phosphate positive electrode material prepared according to Comparative Example 1 above.

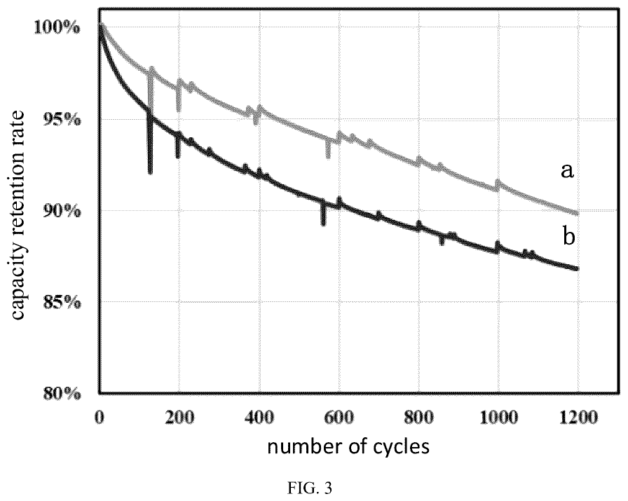

FIG. 3 is a cycle performance test diagram of two kinds of energy storage batteries according to an embodiment of the present disclosure, where curve a corresponds to Embodiment 13, and curve b corresponds to Comparative Example 12. The conditions of cycle performance test refer to performing charging and discharging at a temperature of 45° C. and a charging and discharging power of IP, where the cycle voltage is in a range of 2.5 V˜3.65 V, and the number of cycles is 1200 times.

Comparing the cycle performance test results of Embodiment 13 and Comparative Example 12, it can be found that compared with the conventional lithium iron phosphate battery, the composite lithium iron phosphate positive electrode material is prepared by using the method for preparing the positive electrode material of the embodiment of the disclosure, and then the composite lithium iron phosphate positive electrode material is used to prepare the positive electrode sheet of the battery, the obtained energy storage battery has a good capacity retention rate, and the capacity retention rate can still reach about 90% after 1,200 cycles.

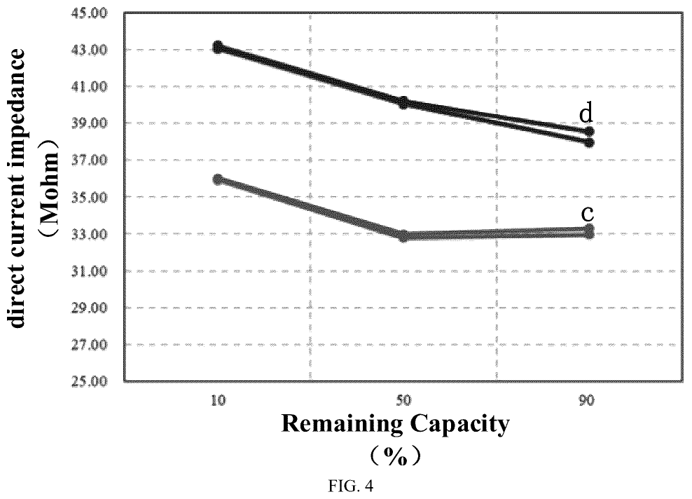

FIG. 4 is a direct current impedance (DCR) test diagram of two energy storage batteries according to an embodiment of the present disclosure, where curve c corresponds to the test results of two replicate samples in Embodiment 13, and curve d corresponds to the test results of two replicate samples of Comparative Example 12. In the DC impedance test, an internal resistance of the energy storage battery is calculated by using a difference between the voltage at the moment before the end of discharge and the stabilized voltage after the end of discharge in the intermittent discharge process.

By comparing the DC impedance test results of Embodiment 13 and Comparative Example 12, it can be found that, compared with the conventional lithium iron phosphate battery, the composite lithium iron phosphate positive electrode material is prepared by adopting the method for preparing the positive electrode material of the embodiment, and then the positive electrode sheet of the battery is made by using the composite lithium iron phosphate positive electrode material, and the obtained energy storage battery has lower DC impedance, and the performance of the energy storage battery is improved.

According to the method for preparing the positive electrode material and the energy storage battery provided in the embodiments of the present disclosure, in the method for preparing the positive electrode material, the first iron source is reacted with the cyanamide organic ligands to prepare the iron-based metal-organic framework material (Fe-MOF), and then the Fe-MOF is blended and sintered with the second iron source, the lithium source, and the phosphorus source to obtain the composite lithium iron phosphate positive electrode material. The second iron source, the lithium source, and the phosphorus source are reacted with each other to generate lithium iron phosphate particles, and the Fe-MOF is sintered to form the iron-wrapped carbon nanotubes, and the lithium iron phosphate particles are attached to the surface of the carbon nanotubes in microstructure. The ligands in Fe-MOF are the cyanamide organic ligands. The ligands may form nitrogen-doped bamboo-like the carbon nanotubes after high-temperature sintering, and the active sites of iron (Fe) are wrapped at the front end of the carbon nanotubes. The unique carbon coating structure can protect and fix the active sites of Fe to improve the stability of the Fe. In addition, the nitrogen-doped carbon nanotubes can provide efficient electron transport channels to form a continuous three-dimensional conductive network, which can be beneficial to improve the electronic conductivity of the composite lithium iron phosphate positive electrode material and the diffusion rate of lithium ions. In addition, the carbon volatilized by the cyanamide organic ligands during high-temperature sintering can be used as a carbon source to form a carbon-coated layer on the surface of lithium iron phosphate particles without adding additional carbon sources. The carbon-coated lithium iron phosphate particles are beneficial to improve the conductivity of composite lithium iron phosphate positive electrode materials.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “has,” “having,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

In addition, when parts such as a layer, a film, a region, or a plate is referred to as being “on” another part, it may be “directly on” another part or may have another part present therebetween. In addition, when a part of a layer, film, region, plate, etc., is “directly on” another part, it means that no other part is positioned therebetween.

It shall be understood by those skilled in the art that the above-described embodiments are specific embodiments for carrying out the present disclosure, and that various changes in form and detail may be made thereto in practical application without departing from the spirit and scope of the present disclosure. Any person skilled in the art can make various changes and modifications without departing from the spirit and scope of the present disclosure, and therefore, the scope of protection of the present disclosure should be based on the scope defined by the claims.

What is claimed is:

1. A method for preparing a positive electrode material, comprising:
preparing an iron-based metal-organic framework material (Fe-MOF), wherein a metal element of the Fe-MOF includes iron and organic ligands of the Fe-MOF are cyanamide organic ligands, wherein preparing the Fe-MOF comprises:
dispersing a first iron source in a solvent;
adding the cyanamide organic ligands into the solvent having the first iron source to perform reflux reaction to obtain a reaction solution; and
performing cooling, filtering, and cleaning on the reaction solution to obtain the Fe-MOF;
grinding and blending the Fe-MOF with a second iron source, a lithium source, and a phosphorus source to obtain a premix; and
performing a sintering treatment on the premix under an atmosphere of an inert gas to obtain a composite lithium iron phosphate positive electrode material, wherein the composite lithium iron phosphate positive electrode material includes lithium iron phosphate particles and carbon nanotubes, the lithium iron phosphate particles are attached to a surface of the carbon nanotubes, and there is iron wrapped by each of the carbon nanotubes.

2. The method of claim 1, wherein each of the first iron source and the second iron source is selected from at least one of ferric nitrate, ferric sulfate, ferric acetate, ferric phosphate, ferric chloride, ferrous perchlorate, ferrous phosphate, ferric citrate, ferrous sulfate, ferrous acetate, ferrous nitrate, ferrous oxalate, or ferrous fluoride.

3. The method of claim 1, wherein each of the cyanamide organic ligands is selected from at least one of melamine, dicyandiamide, or cyanamide.

4. The method of claim 1, wherein during preparing of the Fe-MOF, a molar ratio of the cyanamide organic ligands to the first iron source is in a range of 0.2 to 1, a temperature for the reflux reaction is in a range of 80° C. to 180° C., and a time for the reflux reaction is in a range of 2 h to 24 h.

5. The method of claim 1, wherein the Fe-MOF has a specific surface area in a range of 150 m²/g to 1000 m²/g.

6. The method of claim 1, wherein the Fe-MOF has a particle shape of a cube, and the cube has a length of 50 nm to 100 nm.

7. The method of claim 1, wherein the method further comprises:
prior to grinding and blending the Fe-MOF with the second iron source, the lithium source, and the phosphorus source to obtain the premix;
blending the Fe-MOF with an adhesive and water to obtain a mixture, and extruding the mixture into a preset shape;
wherein grinding and blending the Fe-MOF with the second iron source, the lithium source, and the phosphorus source to obtain the premix comprises:
blending the mixture in the preset shape with the second iron source, the lithium source, and the phosphorus source to obtain the premix.

8. The method of claim 7, wherein the preset shape is a cube, a cylinder, or a sphere.

9. The method of claim 7, wherein the adhesive is selected from at least one of polyacrylic acid, carboxymethyl cellulose, polymethyl methacrylate, chitosan, carboxyethyl cellulose, polyvinyl alcohol, polyvinyl butyraldehyde, polyvinylpyridinone, methyl cellulose, or hydroxypropyl cellulose.

10. The method of claim 7, wherein a ratio of mass of the adhesive to mass of the Fe-MOF is in a range of 0.05 to 0.2, and a ratio of mass of the water to mass of the mixture is in a range of 0.1 to 0.5.

11. The method of claim 8, wherein a pressure for extruding the mixture into the preset shape is in a range of 70 kgf/cm² to 250 kgf/cm².

12. The method of claim 1, wherein during the sintering treatment, a sintering temperature is in a range of 500° C. to 850° C., a heating rate is in a range of 1° C./min to 10° C./min, and a sintering time is in a range of 10 h to 24 h.

13. The method of claim 1, wherein the composite lithium iron phosphate positive electrode material has a specific surface area of 5 m²/g to 20 m²/g, and a particle size corresponding to that a cumulative particle size distribution percentage of particles of the composite lithium iron phosphate positive electrode material reaches 50% is in a range of 50 nm to 2000 nm.

14. The method of claim 1, wherein the solvent is selected from at least one of dimethylformamide (DMF), diethylformamide (DEF), dimethylacetamide (DMA), water, ethanol, methanol, ethanol, propanol, or acetone.

15. The method of claim 1, wherein a surfactant is added into the solvent with the cyanamide organic ligands, and the surfactant is selected from at least one of cetyltrimethyl ammonium bromide, sodium dodecylbenzene sulfonate, polyvinylpyrrolidone, ammonium dodecylsulfate, dodecylbenzene sulfonic acid.

16. The method of claim 15, wherein a molar ratio of the surfactant to the cyanamide organic ligands is in a range of 0.1 to 0.3.

17. The method of claim 1, wherein the lithium source is selected from at least one of lithium carbonate, lithium hydroxide, lithium nitrate, lithium sulfate, lithium phosphate, lithium permanganate, lithium metaphosphate, lithium fluoride, lithium bromide, lithium oxalate, lithium formate, lithium citrate, lithium salicylate, lithium trifluoroacetate, lithium acetoacetate, lithium difluorophosphate, lithium hexafluorophosphate, lithium benzoate, lithium pyruvate, or lithium acetate.

18. The method of claim 1, wherein the phosphorus source is selected from at least one of diammonium hydrogen phosphate and ammonium dihydrogen phosphate.

19. The method of claim 1, wherein grinding and blending the Fe-MOF with the second iron source, the lithium source, and the phosphorus source is achieved by performing ball milling treatment, wherein a rotational speed of the ball milling treatment is in a range of 100 rpm/min to 400 rpm/min, and a time required for the ball milling treatment is in a range of 0.5 h to 2 h.

20. The method of claim 1, wherein a carbon coating content of the composite lithium iron phosphate positive electrode material is in a range of 0.1% to 1.5%, wherein the carbon coating content is expressed by a mass fraction of carbon in the composite lithium iron phosphate positive electrode material.
